(19) United States
(12) Patent Application Publication
(10) Pub. No.: US 2006/0148535 A1
(43) Pub. Date: Jul. 6, 2006

(54) Call setup for a wireless mobile network and supporting method, apparatus, and readable medium

(76) Inventors: Bradley R. Schaefer, Chandler, AZ (US); Mark L. Shaughnessy, Phoenix, AZ (US); Ronald T. Crocker, St. Charles, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/027,634

(22) Filed: Dec. 30, 2004

(51) Int. Cl. H04B 1/38

(52) U.S. Cl. 455/574

(57) ABSTRACT

In the present technique of a call setup process, a short data burst packet is sent (106) in response to the target mobile unit being selected (104), which is followed by a call setup function being initiated (108) to establish a communication channel between a originator mobile unit and the target mobile unit as a response to the short data burst packet being sent.

### TECHNICAL FIELD

This invention relates generally to call setup on a wireless mobile dispatch network.

### BACKGROUND

Battery conservation on mobile units or devices is a major concern in wireless communication systems. As a way to preserve battery life, these mobile units will become inactive (e.g., dormant) on their radio frequency (“RF”) channels after a short period of inactivity of usage for data services, which is generally about 30 to 60 seconds. As a result of the mobile units being dormant and prior to when a dispatch call function can be enabled, the originator mobile unit (e.g., the mobile unit originating the dispatch call) and the target mobile unit (e.g., the mobile unit with which the originator mobile unit sets up the dispatch call) must transition from the inactive state to the active state (e.g., using the RF resources) as part of a call setup. In other words, once a mobile unit is in the active state, only then can an RF channel be established, thereby enabling the mobile unit to transmit and/or receive data via the channel.

One problem is that for a typical wireless mobile network, the time required to transition the originator mobile unit from the dormant state to the active state can be as much as 3 seconds or more. This transition time requirement applies to both the originator mobile unit and the target mobile unit. In addition, more time is usually needed to page the mobile device. Current call setup systems, however, do not compensate for required transmission time over the air and call processing time. Thus, adding these time delays, the total time required to effectuate a dispatch call between the originator mobile unit and the target unit can be 10 seconds or greater. With such long latency start times, the advantage of the dispatch call service as an instant communication is greatly diminished.

In order to shorten call setup time of dispatch calls, one prior method takes prospective action on the originator mobile unit to wake up the originator mobile and the target mobile unit. After the originator mobile unit has transitioned from the dormant state to the active state and a target mobile unit has been selected, a wakeup packet is sent to the target mobile unit to initiate transition of the target mobile unit from dormant to active state. As a result, the time needed to complete a call setup of the dispatch call is reduced, since the originator mobile and the target mobile unit are awakened from the dormant state prior to call setup initiation. Although this method reduces setup delay time, it wastes RF resources unnecessarily because RF resources are being utilized after premature trigger functions that require an unneeded wait time, such as while the user is selecting the target mobile unit, which may be a long time before the user actually makes a target selection.

### BRIEF DESCRIPTION OF THE DRAWINGS

The above needs are at least partially met through provision of the dispatch call setup process described in the following detailed description, particularly when studied in conjunction with the drawings, wherein:

FIG. 1 comprises a block diagram of a typical wireless dispatch communication system suitable for various embodiments of the invention;

FIG. 2 comprises a block diagram of a general mobile unit suitable for various embodiments of the invention;

FIG. 3 comprises a call diagram of the call setup process according to various embodiments of the invention; and

FIG. 4 comprises a flow diagram of the call setup process according to one embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a dispatch call setup process has been provided, which triggers a short data burst packet that includes an identity of a target mobile unit to be sent to the target mobile unit responsive to the selection of the target mobile unit. According to various embodiments, in response to the short data burst packet, the target mobile unit is able to immediately transition from a dormant state to an active state, which results in an RF link between the originator mobile unit and the target mobile unit being established prior to the initiation of the communication channel. According to one embodiment, the originator mobile unit also transitions from the dormant state to the active state responsive to the sending of the short data burst packet in order to improve the start delay time. According to another embodiment, the originator mobile unit transitions from the dormant station to the active state in response to the initiation of the call setup function.

According to another embodiment, the communication channel is based on a Code Division Multiple Access system. Although not necessarily being system-specific, the short data burst packet can be a dummy packet or a packet with configuration information needed for the call setup function. In various embodiments, the call setup function relates to any one or more calls of a push-to-talk call, a telephone call, multimedia session call, or a Voice over Internet Protocol (“VoIP”) call. Through these various teachings, the call setup delay time is reduced with a minimum RF cost. For example, unlike the prior art, the RF resources are not wasted while the user is selecting from the address book, which can be a long wait period. Moreover, because the short data burst packet provides a very small payload that can be quickly sent to the network, the time needed for lengthy traffic channel establishment procedures is comparably reduced. Specifically, the waste of RF resources is reduced compared to the standard originator speculation. On the other hand, when the present embodiments are combined with the originator speculation, the performance gain is also improved with various teachings described.

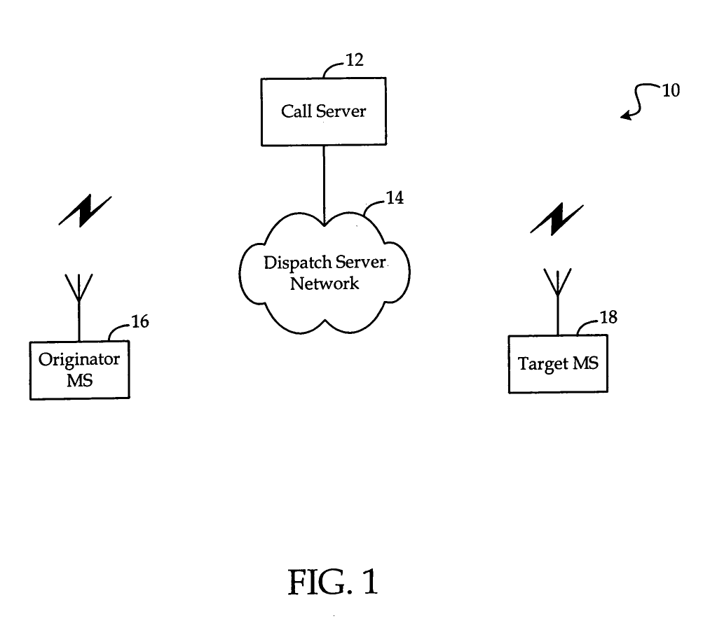

Referring now to the drawings, and in particular to FIG. 1, for purposes of providing an illustrative but nonexhaustive example to facilitate this description, a specific operational paradigm using a wireless dispatch system is shown and indicated generally at 10. Those skilled in the art, however, will recognize and appreciate that the specifics of this illustrative example are not specifics of the invention itself and that the teachings set forth herein are applicable in a variety of alternative settings. For example, since the teachings described are not platform dependent, they can be applied to various systems, such as a Code Division Multiple Access (CDMA) system or a Time Division Multiple Access (TDMA) system. In fact, any wireless networks are contemplated and are within the scope of the invention. As such, the CDMA system and other systems are contemplated as a family of technologies, which also includes access mechanisms such as High-Speed Downlink Packet Access (HSDPA) as specified by the 3^{rd} Generation Partnership Project (“3GPP”) and High Rate Packet Data-Revision A (“HRPD-A”) as specified by the 3^{rd} Generation Partnership Project 2 (“3GPP2”). Moreover, depending on the type of system implemented, the call function contemplated includes a push-to-talk call, a telephone call, multimedia session call, and/or a Voice over Internet Protocol (“VoIP”) call.

Referring to the exemplary dispatch call network shown in FIG. 1, a call server 12 is operably connected to a dispatch server network 14 that enables dispatch calls between an originator mobile unit 16 and a target mobile unit 18. Generally, to conserve batteries and system resources, the originator and the target mobile units 16, 18 would be in a dormant state. During this dormant state, no active RF data link would couple the mobile units 16, 18 to the network 14. In these various embodiments, as soon as the originator mobile unit 16 selects the target mobile unit 18, a short data burst packet is sent from the originator mobile unit to the target mobile unit via the dispatch server network 14. Specifically, the call server 12 is generally used to route any packet exchange between the originator mobile unit 16 and the target mobile unit 18. The short data burst packet preemptively wakes up the target mobile unit 18 prior to the initiation of the standard call setup procedures. As a result, the startup delay of any call setup in the system is reduced.

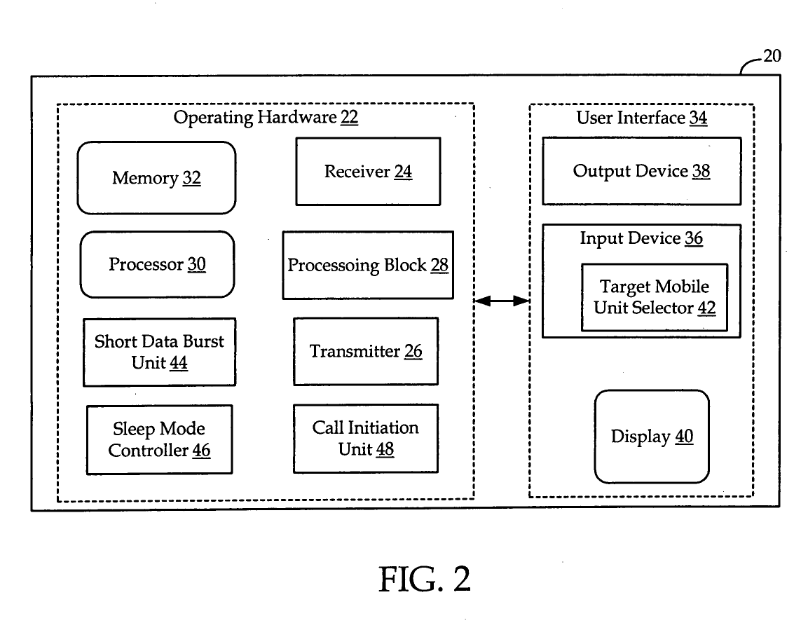

Referring to FIG. 2, a typical mobile unit 20 suitable for various embodiments is shown. With most typical operating hardware 22 for mobile units, a receiver 24 and a transmitter 26 for respectively receiving and transmitting signals and/or data packets to and from the call server 12 (shown in FIG. 1) are included. Also included is a processing block 28 for translating the signals and data packets to and from the receiver 24 and transmitter 26, respectively; a processor 30 for calculating the translations; and a memory 32 for storing the executable instructions and/or data. The operating hardware 22 is generally connected to a user interface 34, which includes at least one input device 36, at least one output device 38, and a display 40.

Users, through the use of the user interface 34, are able to input and output various functions and selections. For example, a user of the originator mobile unit 16 can easily select the target mobile unit 18 via a target mobile unit selector 42 of the input device 36, which triggers a short data burst unit 44 to send a short data burst packet out to the network via the transmitter. In one embodiment, responsive to the short data burst packet being sent onto the network, the mobile unit 20 is transitioned from the dormant state to the active state by a sleep mode controller 46. After the mobile unit 20 is in active state, a call initiation unit 48 initiates a call setup function in order to establish a communication channel between the originator mobile unit and the target mobile unit. The inner workings of the mobile unit 20 are readily appreciated by one skilled in the art. FIG. 2 is shown as an illustrative example, and thus any typical mobile unit can be modified to implement the various teachings described.

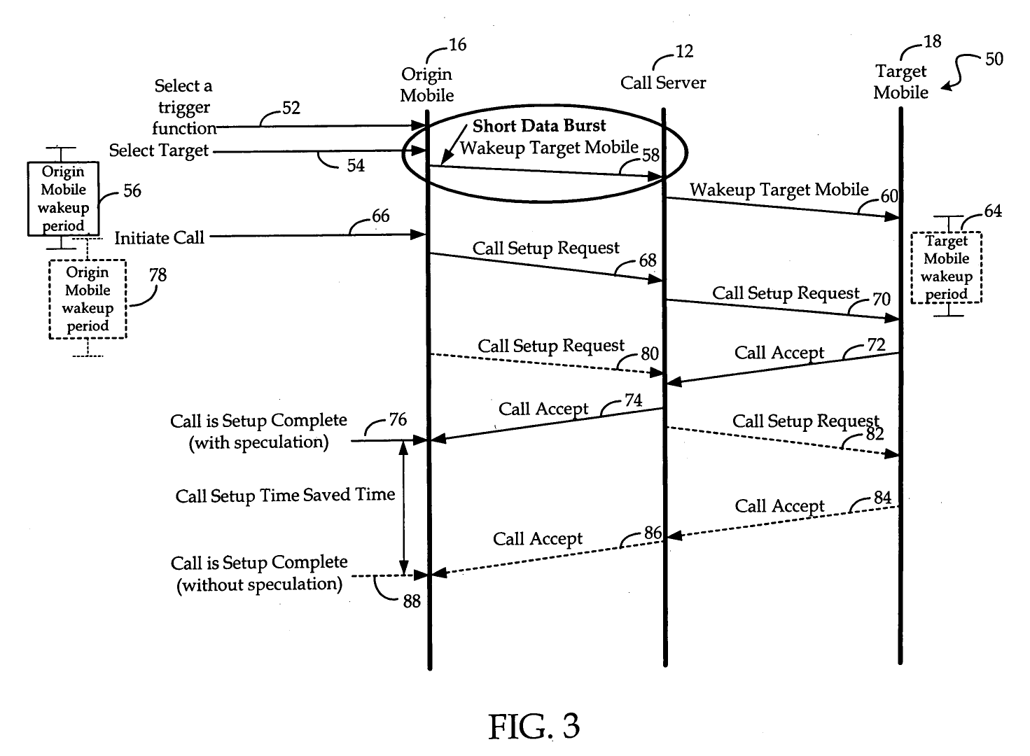

Turning now to FIG. 3, a call diagram of the call setup process according to various embodiments of the invention is shown and indicated generally at 50. Two implementations of a call setup process with speculation and a call setup process without speculation are shown. Speculation, as commonly known in the art, relates to a method that transitions a mobile station from a dormant state to an active radio frequency state based on speculative actions of the user of the mobile station. For example, with the use of speculation, the originator mobile station transitions from dormant state to the active state as soon as the speculative action has been performed, such as the user opening the phone book. In contrast, in the various embodiments without speculation, the originator mobile station is preferably not transitioned from dormant to active until after a target has been selected. In particular, as shown, the origin or originator mobile unit first selects 52 a trigger function. In the prior art standard speculation call process, this selection of the trigger function, such as opening the address book, invokes a wake up call to the origin mobile unit to transition it from dormant to active communication state. Unlike the prior art, however, the various teachings allows the transition from dormant to active communication state to wait until the user selects a target mobile unit. Thus, the time spent active on an RF channel is minimized. Furthermore, unlike the prior art where no communication could occur until the origin mobile unit's wake up period 56 had elapsed and the originator mobile unit is active on the RF channel, the communication starts as soon as the originator mobile unit sends 58 a wake-up message using short data burst to the target mobile unit. In one embodiment, the originator mobile unit immediately sends the short data burst wake up message to the target mobile unit responsive to the target mobile unit being selected. The short data burst is sent prior to the completion of the transition to active communication state. Compared to the prior standard speculation, this embodiment uses fewer RF resources and starts the process of waking up the target mobile unit much sooner. This results in faster overall setup time, since the target mobile unit is active and waiting to receive the call setup request.

In this embodiment with speculation, both the origin mobile unit and the target mobile unit are awakened with the selection of the trigger function. Specifically, as soon as the target mobile unit 18 is selected 54 by the origin mobile unit 16, a short data burst packet is sent 58 to the call server 12, which is in turn forwarded 60 to the target mobile unit. As a result, the target mobile unit is awakened from the dormant state during the wake up period 64 such that it can be sent the wake up short data burst packet. Note that the short data burst packet is sent at the selection of the target mobile unit on the origin mobile unit in both implementations with and without speculation.

Once the short data burst packet has been sent and the origin wake up period has elapsed, the origin mobile unit 16 initiates 66 the call setup function to begin the call setup procedure with the target mobile unit 18. In particular, a call setup request is sent 68 to the call server 12, which is again forwarded 70 to the target mobile unit 18. Since the target mobile unit 16 was previously transitioned from the dormant state to the active state with the sending of the short data burst packet, the target mobile unit 16 can quickly respond 72 with a call accept message to the call server 12. The call server 12 accordingly forwards 74 the call accept message to the origin mobile unit 16, which completes 76 the call setup for the implementation with speculation. Note that with the speculation implementation, the exchange between the origin mobile unit 16 and the target mobile unit 18 is fairly instantaneous. Since the wake up delays have already occurred, the only delays that are incurred on the call setup 68, 70 and accept messages 72, 74 are the normal transport delays associated with the packet data network.

In the implementation without the speculation, the origin mobile unit does not begin its wakeup period 78 until the call setup function has been initiated. In this case, the origin mobile unit 16 transitions from the dormant to the active state when the call setup is initiated, meaning there is a lag time for the transition before the call setup request can be sent 80 to the call server 12. In this implementation, there is extra delay in the startup time as compared to the implementation with speculation, because the origin mobile unit does not begin its transition until the call setup function has been initiated. The origin mobile unit, however, must wait until the transition is complete before it can send 80 the call setup request to the call server 12. When this is done, the call server 12 accordingly forwards 82 the call setup request to the target mobile unit 18 that has been active and ready. The target mobile unit quickly responds 84 to the call setup request with a call accept message without the transition delay time of the target mobile. The call server accordingly sends 86 the call accept message to the origin mobile unit, and the call setup process is complete 88. As shown, there is a definite startup delay time difference between the implementation with speculation and without speculation in that the speculation implementation is faster.

While the implementation with speculation provides for fast startup time, more RF resources are used in these embodiments (e.g., more time is spent in an active RF channel state). In contrast, less RF resources are being used for the implementation without speculation, but the tradeoff is longer delay of the startup time. Depending on the network and system, one may be more preferable than the other. Nonetheless, these various implementations are contemplated and readily appreciated by one skilled in the art, and they are within the scope of the various teachings shown.

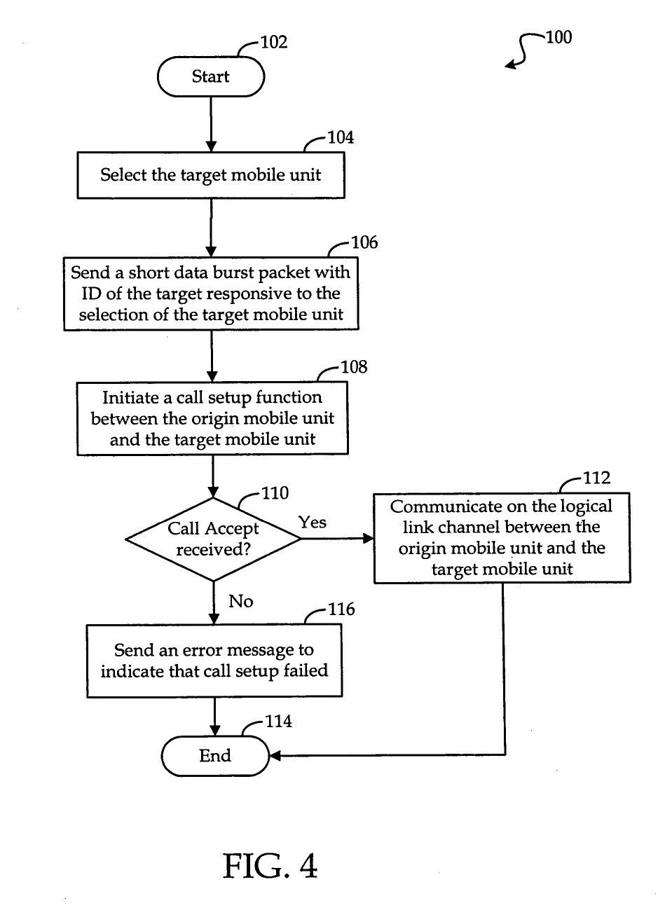

Turning now to FIG. 4, a flow diagram of the call setup process according to one embodiment is shown and indicated generally at 100. Although the process shown is preferably implemented at the originator mobile unit, there may be other implementations that are better suited for a call server or other component in the network 14. As a skilled artisan would readily appreciate, the flow diagram may be altered according to these different implementations. Furthermore, the speculation procedures that cause the originator mobile unit to transition from dormant to active mode are not shown since they may or optionally may not be occurring in the background of this call setup process. And as such, other embodiments of the call setup process are contemplated and are within the scope of the various teachings shown. In light of this, this particular process shown starts 102 with the selection 104 of the target mobile unit, which is preferably done on the originator mobile unit. In response to the selection, a short data burst packet with the identity of the target mobile unit is sent or forwarded 106 to the target mobile unit. After such a short data burst packet is sent, the originator mobile unit preferably initiates 108 the call setup function to start the call setup procedure with the target mobile unit. The process then waits for a response from the target mobile unit and determines 110 whether a call accepted message has been received from the target mobile unit. If so, the call is setup and the mobile units begin to communicate 112 on the logical link channel, which completes 114 the call setup process. If, on the other hand, a call accepted message has not been received after a predefined time, an error message is sent 116 to the originating user to indicate that the call setup failed, and the process ends 114 at this point.

With these various teachings shown, a novel call setup technique has been provided. As a result of the various teachings shown, the call setup delay time is reduced with minimum RF cost. Instead of wasting the RF resources on premature speculation trigger functions, which occurred, for example, while the user selects from the address book, the various embodiments provide a way to wake up the target mobile unit with the short data burst packet and the originator mobile unit with the selection of the target mobile unit. Since the short data burst packet provides a very small payload that can be quickly sent to the network, the delay time of the lengthy traffic channel establishment procedures are reduced. Additionally, the transition time of the mobile units is shortened and any waste of the RF resources is minimized.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of setting up a communication channel between an originator mobile unit and a target mobile unit comprising:
selecting the target mobile unit;
sending a short data burst packet to the target mobile unit responsive to selecting the target mobile unit, wherein the short data burst packet identifies the target mobile unit;
initiating a call setup function to establish the communication channel between the originator mobile unit and the target mobile unit responsive to sending the short data burst packet.

2. The method according to claim 1, wherein the target mobile unit transitions from a dormant state to an active state responsive to the short data burst packet, thereby a radio frequency link between the originator mobile unit and the target mobile unit is established prior to initiation of the communication channel.

3. The method according to claim 1, wherein the originator mobile unit transitions from a dormant state to an active state responsive to sending the short data burst packet.

4. The method according to claim 1, wherein the originator mobile unit transitions from a dormant state to an active state responsive to initiating the call setup function.

5. The method according to claim 1, wherein the communication channel comprises any one or more selected from a group of a Code Division Multiple Access system, a High-Speed Downlink Packet Access, and a High Rate Packet Data-Revision A.

6. The method according to claim 1, wherein the short data burst packet comprises any one or more selected from a group of a dummy packet and a packet with configuration information.

7. The method according to claim 1, wherein the call setup function comprises any one or more selected from a group of a push-to-talk call setup function, a telephone call function, multimedia session call function, and a voice over Internet Protocol call function.

8. A readable medium having executable instructions for:
selecting a target mobile unit;
sending a short data burst packet to the target mobile unit responsive to selecting the target mobile unit, wherein the short data burst packet identifies the target mobile unit;
initiating a call setup function to establish a communication channel between an originator mobile unit and the target mobile unit responsive to sending the short data burst packet.

9. The readable medium according to claim 8, wherein the target mobile unit transitions from a dormant state to an active state responsive to the short data burst packet, thereby a radio frequency link between the originator mobile unit and the target mobile unit is established prior to initiation of the communication channel.

10. The readable medium according to claim 8, wherein the originator mobile unit transitions from a dormant state to an active state responsive to sending the short data burst packet.

11. The readable medium according to claim 8, wherein the originator mobile unit transitions from a dormant state to an active state responsive to initiating the call setup function.

12. The readable medium according to claim 8, wherein the communication channel comprises any one or more selected from a group of a Code Division Multiple Access system, a High-Speed Downlink Packet Access, and a High Rate Packet Data-Revision A.

13. The readable medium according to claim 8, wherein the short data burst packet comprises any one or more selected from a group of a dummy packet and a packet with configuration information.

14. The readable medium according to claim 8, wherein the call setup function comprises any one or more selected from a group of a push-to-talk call setup function, a telephone call function, multimedia session call function, and a voice over Internet Protocol call function.

15. A two-way wireless communications apparatus comprising:
a target mobile unit selector;
a short data burst unit being operably responsive to the target mobile unit selector and having a short data burst output comprising a wakeup message;
a wireless transmitter operably coupled to the short data burst unit and having a wireless output at least comprising the short data burst output.

16. The two-way wireless communications apparatus of claim 15 further comprising:
a sleep mode controller operably responsive to the target mobile unit selector;
a call initiation unit operably responsive to the sleep mode controller and further being operably coupled to the wireless transmitter.

17. The two-way wireless communications apparatus of claim 15, wherein the short data burst unit further comprises a means for facilitating transmission of the short data burst to thereby facilitate initiation of waking up a target mobile unit prior to the target mobile unit receiving a call initiation message as is sourced by the call initiation unit.

18. The two-way wireless communications apparatus of claim 5, wherein the wireless communication comprises any one or more selected from a group of a Code Division Multiple Access system, a High-Speed Downlink Packet Access, and a High Rate Packet Data-Revision A.
